(19) United States
(12) Patent Application Publication
(10) Pub. No.: US 2013/0106707 A1
(43) Pub. Date: May 2, 2013

(54) METHOD AND DEVICE FOR GESTURE DETERMINATION

(71) Applicant: JIA-MING CHEN, Taipei City (TW)

(72) Inventor: JIA-MING CHEN, Taipei City (TW)

(73) Assignee: EGALAX_EMPIA TECHNOLOGY INC., Taipei City (TW)

(21) Appl. No.: 13/281,509

(22) Filed: Oct. 26, 2011

(51) Int. Cl. G06F 3/041

(52) U.S. Cl. 345/173

(57) ABSTRACT

The method and the device for gesture determination are disclosed. The device has a touch sensor and a controller for providing touch position. The device also has a processor for determining a gesture according to the successive touch positions. A single gesture can be used for a plurality of distinct applications. The processor can also trigger a command of the current foreground application to which the determined gesture corresponds.

### BACKGROUND OF THE INVENTION

1. Field of the Invention

The present invention relates to a device and a method for gesture determination, and more particularly, to a device and a method for determining gestures, wherein the same gesture corresponds to more than one distinct applications.

2. Description of the Prior Art

A touch sensor or a touch pad or a digitizer can provide detection information relating to objects thereon. Motions of the moving objects can be recorded according to a detection information controller, so a gesture represented by the motion can be determined, providing another way of inputting commands, other than through keyboards and mice.

Conventionally, gestures are mostly used for simulating mouse operations, or correspond to specific commands in specific applications. For example, in an image display program, zoom-out and zoom-in commands can be provided by pinching and spreading with two fingers, respectively. However, the same gesture may mean different requirements in different applications. When applications and the operating system employ the same gesture to execute different commands, conflicts may occur. As a result, the applications and the operating system need to avoid using the same gesture.

From the above it is clear that prior art still has shortcomings. In order to solve these problems, efforts have long been made in vain, while ordinary products and methods offering no appropriate structures and methods. Thus, there is a need in the industry for a novel technique that solves these problems.

### SUMMARY OF THE INVENTION

An objective of the present invention is to provide a method and a device for gesture determination. The device has a touch sensor and a controller for providing touch position. The device also has a processor for determining a gesture according to the successive touch positions. A single gesture can be used for a plurality of distinct applications. The processor can also trigger a command of the current foreground application to which the determined gesture corresponds.

The objectives and technical solutions of the present invention can be accomplished by the following technical scheme. According to the present invention, a method for gesture determination is proposed, comprising: providing a lookup table, the lookup table recording at least one gesture pattern and a trigger to which each gesture corresponds, wherein each trigger corresponds to a system or an application command; obtaining detection information by a sensor; determining one or more positions of one or more objects approaching or touching the sensor based on the received detection information; determining one or more motions of the one or more objects based on the one or more positions of the one or more objects approaching or touching the sensor; comparing the one or more motions of the one or more objects with the at least one gesture pattern to determine a matched gesture; comparing the matched gesture with triggers corresponding to at least one application to determine a matched trigger; and triggering the command to which the matched trigger correspond once the matched trigger is determined.

The objectives and technical solutions of the present invention can further be accomplished by the following technical schemes.

The method for gesture determination further includes when there is no match between the matched gesture and the triggers corresponding to the at least one application, comparing the matched gesture with triggers corresponding to the system to determine a matched trigger.

The method for gesture determination further includes determining a currently executed foreground application, and the at least one application including the foreground application.

The method for gesture determination further includes selecting a plurality of applications based on the one or more motions of the one or more objects.

The applications are sorted applications, and these sorted applications match the trigger to which the matched gesture corresponds in order, and the first matched trigger is considered as the matched trigger.

The method for gesture determination further includes sorting these applications and generating a triggering lookup table based on the sorted applications, wherein a gesture corresponding to a plurality of applications corresponds only to a trigger for an application with the highest ranking among these applications in the triggering lookup table and the determination of a matched trigger is performed by comparing the matched gesture with triggers in the triggering lookup table.

The method for gesture determination further includes displaying pictures representing the corresponding gestures in the triggering lookup table, wherein the triggering lookup table is generated depending on the one or more motions of the one or more objects before the matched gesture is determined.

When the selected applications include a foreground application and a background application, the foreground application has a higher ranking than the background application.

The selected applications are determined based on a starting position, an ending position, or a converged range of the one or more motions of the one or more objects.

The lookup table and successive positions on the sensor approached or touched by the one or more objects are stored in a storage unit.

The objectives and technical solutions of the present invention can be accomplished by the following technical scheme. According to the present invention, a device for gesture determination is proposed, comprising: a lookup table for recording at least one gesture pattern and a trigger to which each gesture corresponds, wherein each trigger corresponds to a system or an application command; a sensor for obtaining detection information; a controller for determining one or more positions of one or more objects approaching or touching the sensor based on the received detection information; a processing including: determining one or more motions of the one or more objects based on the one or more positions of the one or more objects approaching or touching the sensor; comparing the one or more motions of the one or more objects with the at least one gesture pattern to determine a matched gesture; comparing the matched gesture with triggers corresponding to at least one application to determine a matched trigger; and triggering the command to which the matched trigger correspond once the matched trigger is determined.

The objectives and technical solutions of the present invention can be further accomplished by the following technical schemes.

The processor further includes when there is no match between the matched gesture and the triggers corresponding to the at least one application, comparing the matched gesture with triggers corresponding to the system to determine a matched trigger.

The processor further includes determining a currently executed foreground application, and the at least one application including the foreground application.

The processor further includes selecting a plurality of applications based on the one or more motions of the one or more objects.

The applications are sorted applications, and the processor match these sorted applications with the trigger to which the matched gesture corresponds in order, and the first matched trigger is considered as the matched trigger.

The processor further includes sorting these applications and generating a triggering lookup table based on the sorted applications, wherein a gesture corresponding to a plurality of applications corresponds only to a trigger for an application with the highest ranking among these applications in the triggering lookup table and the determination of a matched trigger is performed by comparing the matched gesture with triggers in the triggering lookup table.

The processor further includes displaying pictures representing the corresponding gestures in the triggering lookup table, wherein the triggering lookup table is generated depending on the one or more motions of the one or more objects before the matched gesture is determined.

When the selected applications include a foreground application and a background application, the foreground application has a higher ranking than the background application.

The selected applications are determined based on a starting position, an ending position, or a converged range of the one or more motions of the one or more objects.

The device for gesture determination further includes a storage unit for storing the lookup table and successive positions on the sensor approached or touched by the one or more objects.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart illustrating a method for gesture determination in accordance with the present invention;

FIG. 2 is a block diagram illustrating a device for gesture determination in accordance with the present invention;

FIG. 3 is a schematic diagram illustrating a lookup table in accordance with the present invention; and

FIG. 4 is a schematic diagram illustrating an operation in accordance with the present invention.

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

The present invention is applicable to electronic apparatuses with displays, including but not limited to, computers, mobile phones, portable electronic apparatuses (e.g. PDA), etc. One or more applications can be executed and displayed on the electronic apparatus. The operating system and applications of the electronic apparatus can be executed by a processor. In addition, the electronic apparatus may further include a touch-sensitive device including a sensor for providing detection information of touch positions. The touch-sensitive device is used as a user input, and may include but is not limited to being embedded in or positioned on top of the display, it may also be independent of the display.

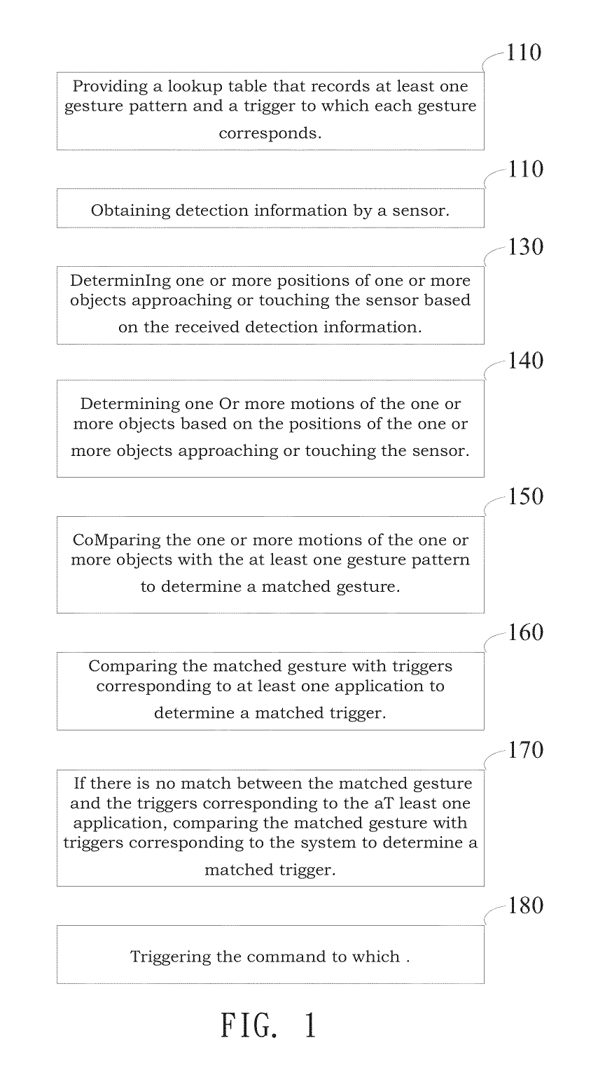

Referring to FIG. 1, a flowchart illustrating a method for gesture determination in accordance with the present invention is shown. First, as shown in step 110, a lookup table is provided. The lookup table records at least one gesture pattern and a trigger to which each gesture corresponds, wherein each trigger corresponds to a system command or an application command.

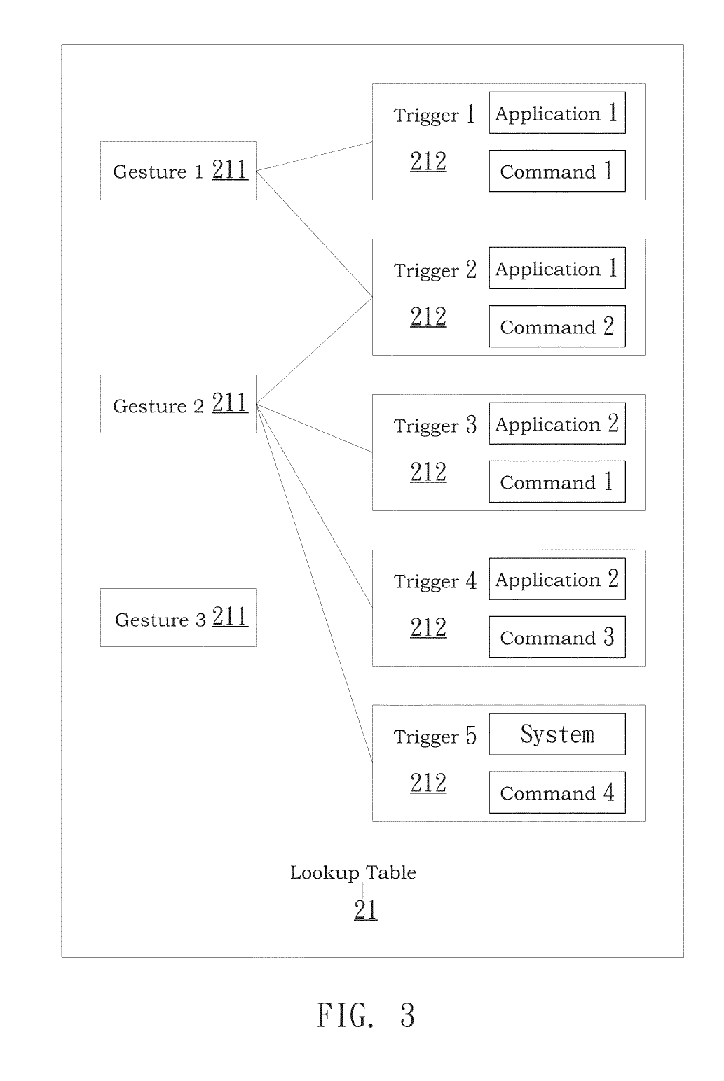

Referring to FIG. 3, a schematic diagram illustrating an exemplary lookup table in accordance with the present invention is shown. The lookup table 21 may include a plurality of gestures 211 (e.g. Gesture 1, Gesture 2, and Gesture 3), and a plurality of triggers (e.g. Trigger 1, Trigger 2, Trigger 3, Trigger 4, and Trigger 5). Each gesture can correspond to one or more triggers (e.g. Gestures 1 and 2) or not correspond to any trigger (e.g. Gesture 3). Each trigger corresponds to a system or application command.

In addition, a system command may simulate an output or input command of other input devices. It may also activate a specific program command. Thus, the same gesture can correspond to different system or application commands. One with ordinary skill in the art can appreciate that the lookup table can be implemented by a hardware circuit or software, the application of which is well known and thus will not be repeated herein.

As shown in step 120, detection information is obtained by a sensor. One with ordinary skill in the art can appreciate that the sensor may include but is not limited to capacitive, resistive, optical, surface acoustic wave touch sensor. The representation of the detection information may include but is not limited to analog signal, digital signal or numerical representation.

In addition, as shown in step 130, one or more positions approached or touched by one or more objects is/are determined based on the received detection information. In a sensor, including but not limited to a capacitive or optical (IR based or camera based) sensor, before an object actually touches the sensor, the sensor may be able to provide detection information of the object, so proximity or touch related detection information may be put to different uses.

As shown in step 140, one or more motions of the one or more objects is/are determined based on the one or more positions on the sensor approached or touched by the one or more objects. The sensor of the present invention may provide detection information of one or more objects, therefore, it can successively record the detection information of one or more objects to form the motion(s) of one or more objects.

In addition, as shown in step 150, the motion(s) of the one or more objects is compared with the gesture patterns to determine a matched gesture. Said gesture patterns may include but are not limited to gesture patterns of a single motion or multiple motions. In an example of the present invention, a gesture pattern is comprised of line segments in different angles. By comparing the motion of an object with the order in which each line segment appear in each gesture pattern, a gesture matching the motion of the object can be determined.

In addition, as shown in steps 160 and 170, the matched gesture is compared with triggers corresponding to at least one application to determine if there is a matched trigger. If there is no match between the matched gesture and the triggers, then the matched gesture is compared with triggers corresponding to the system to determine if there is a matched trigger. Furthermore, as shown in step 180, when a matched trigger is determined, the command corresponding to the matched trigger is triggered.

In an example of the present invention, the at least one application can be a foreground or focused-on application currently being executed. In other words, the present invention can determine the foreground application current being executed, and find a gesture in the lookup table corresponding to the currently executed foreground application that matches the matched gesture. Accordingly, based on different foreground applications, the trigger that matches the matched gesture is different, and in turn, the command that matches the matched gesture is also different. When there is no match between the matched gesture and a trigger corresponding to the foreground application, then the matched gesture is compared with triggers corresponding to the system to determine if there is a matched trigger.

In another example of the present invention, a plurality of applications are selected based on the motion(s) of one or more objects, and said at least one application includes these selected applications. That is, a matched triggered is determined by comparing the matched gesture with triggers corresponding to the selected applications in the lookup table When there is no match between the matched gesture and the triggers corresponding to the selected applications, then triggers corresponding to the system are compared to determine a matched trigger.

Said selected applications can be determined based on the motion(s) of said one or more objects, for example, based on a starting position, an ending position, or a converged range of the motion of the object. For example, when two objects approach or touch the sensor, the selected applications may include an application which has a display range that encompasses the position(s) of the two objects or at least one of the objects. Alternatively, the selected applications may include an application which has a display range that encompasses a part of or the entire motion(s) of the two objects.

Accordingly, by recording the motion of an object from the beginning, through the course of movement, to the end, the selected applications may include a foreground application and at least one application. The present invention further include sorting the selected applications such that the determination of a matched triggered is performed by comparing the triggers corresponding to the applications in this order, and the first matched trigger is considered as said matched trigger. For example, based on the order in which the applications on the screen are stacked, the matched gesture is first compared with triggers corresponding to the foreground application, and if there is no match between the matched gesture and the triggers corresponding to the foreground application, then the matched gesture is compared with triggers corresponding to the next background application, and so on. If there is no match between the matched gesture and any of the triggers corresponding to all the sorted applications, then the matched gesture is compared with triggers corresponding to the system.

In an example of the present invention, gestures that are available for triggering are prompted. For example, pictures representing the available gestures are displayed, and even descriptions of the commands corresponding to the picture can be displayed. In a preferred example of the present invention, a triggering lookup table is generated based on said sorted applications, wherein a gesture corresponding to a plurality of applications corresponds only to a trigger for an application with the highest ranking among those applications in the triggering lookup table. The determination of a matched trigger is performed by comparing the matched gesture with triggers in the triggering lookup table. For example, a foreground application, a background application and the system all correspond to the same gesture. In the triggering lookup table, only the trigger for the foreground application corresponds to this common gesture. Thus, the triggering lookup table may include triggers of a plurality of applications and/ or the system, and each trigger has a one-to-one relationship with a corresponding gesture.

In addition, the triggering lookup table can be generated depending on the motions of the one or more objects before the matched gesture is determined. Thus, with the change in the motions, the display of pictures representing the available gestures may change accordingly, that is, the generation of the triggering lookup table is before the determination of a matched gesture.

In an example of the present invention, the generation of the triggering lookup table is dynamically generated upon actuation of a command for a system trigger. For example, the triggering lookup table is generated dynamically when one or more objects approach the sensor. That is, when one or more objects approach the sensor, pictures representing the available gestures will then be displayed, so a user can make a gesture based on the prompt of the available gestures. The gesture can be made by physically touching or not touching the sensor.

One with ordinary skill in the art can appreciate that said applications and picture can be displayed on a display, and no further descriptions will be given.

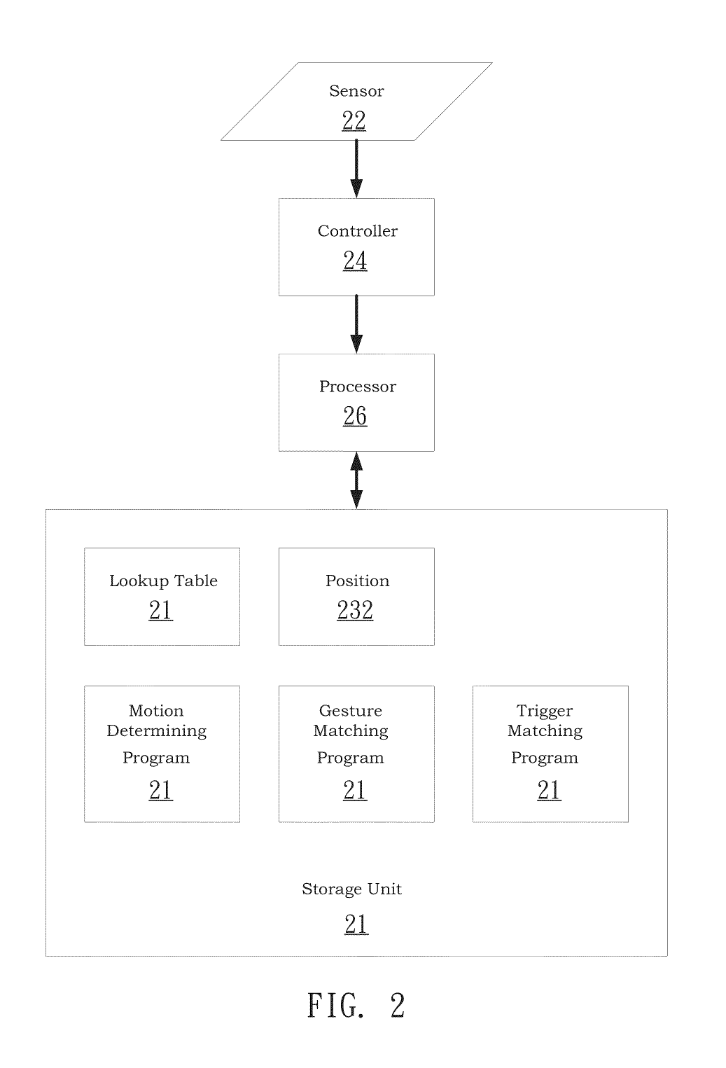

Referring to FIG. 2, a block diagram illustrating a device for gesture determination according to a best mode of the present invention is shown. The device includes a lookup table 21, a sensor 22, a controller 24, a processor 26 and a storage unit 28.

The lookup table 21 can, as described in step 110, record at least one gesture pattern and a trigger corresponding to each gesture, wherein a trigger corresponds to a system or application command, and the lookup table 21 is stored in the storage unit 28. One with ordinary skill in the art the lookup table can be implemented by a hardware circuit or software, its applications are well know and thus not further described. In an example of the present invention, each gesture can correspond to one or more triggers or no trigger. In addition, a system command may simulate an output or input command of other input devices. It may also activate a specific program command. Thus, the same gesture can correspond to different system or application commands.

Moreover, the sensor 22 can, as described in step 120, provide detection information. One with ordinary skill in the art can appreciate that the sensor may include but is not limited to capacitive, resistive, optical, surface acoustic wave touch sensor. The representation of the detection information may include but is not limited to analog signal, digital signal or numerical representation.

The detection information provided by the sensor 22 can be received by the controller 24. The controller 24 can, as described in step 130, determine one or more positions 232 approached or touched by one or more objects based on the received detection information. In a sensor, including but not limited to a capacitive or optical (IR based or camera based) sensor, before an object actually touches the sensor, the sensor may be able to provide detection information of the object, so proximity or touch related detection information may be put to different uses.

The one or more positions 232 approached or touched by the one or more objects can be received by the processor 26. The processor 26 stores successive positions 232 approached or touched by the one or more objects in the storage unit 28, and as described in step 140, can determine one or more motions of the one or more objects based on the successive positions 232 on the sensor approached or touched by the one or more objects. The processor 26 may execute a motion determining program 23 to determine the motions of the objects, wherein the motion determining program 23 may be stored in the storage unit 28.

The processor 26 can further, as described in step 150, compare the motion(s) of the one or more objects is compared with the gesture patterns to determine a matched gesture. Said gesture patterns may include but are not limited to gesture patterns of a single motion or multiple motions. In an example of the present invention, a gesture pattern is comprised of line segments in different angles. By comparing the motion of an object with the order in which each line segment appear in each gesture pattern, a gesture matching the motion of the object can be determined. The processor 26 can execute a gesture matching program 25 to perform the gesture matching process, wherein the gesture matching program 25 may be stored in the storage unit 28.

In addition, the processor 26 can further, as described in steps 160 and 170, compare the matched gesture with triggers corresponding to at least one application to determine if there is a matched trigger. If there is no match between the matched gesture and the triggers, then the matched gesture is compared with triggers corresponding to the system to determine if there is a matched trigger. Furthermore, the processor 26 can further, as described in step 180, trigger the command corresponding to the matched trigger when the matched trigger is determined. The processor 26 can execute a trigger matching program 27 to perform the trigger matching process, wherein the trigger matching program 27 may be stored in the storage unit 28.

One with ordinary skill in the art can appreciate that, as for circuit design, the controller 24 and the processor 26 can be integrated in the same circuit, and the motion determining program 23, the gesture matching program 25, and the trigger matching program 27 can be integrated in the same program. The hardware and software designs of the present invention are not limited to those described. In addition, the processor may include but is not limited to processors provided in a computer, a mobile phone, or a portable digital apparatus (e.g. PDA).

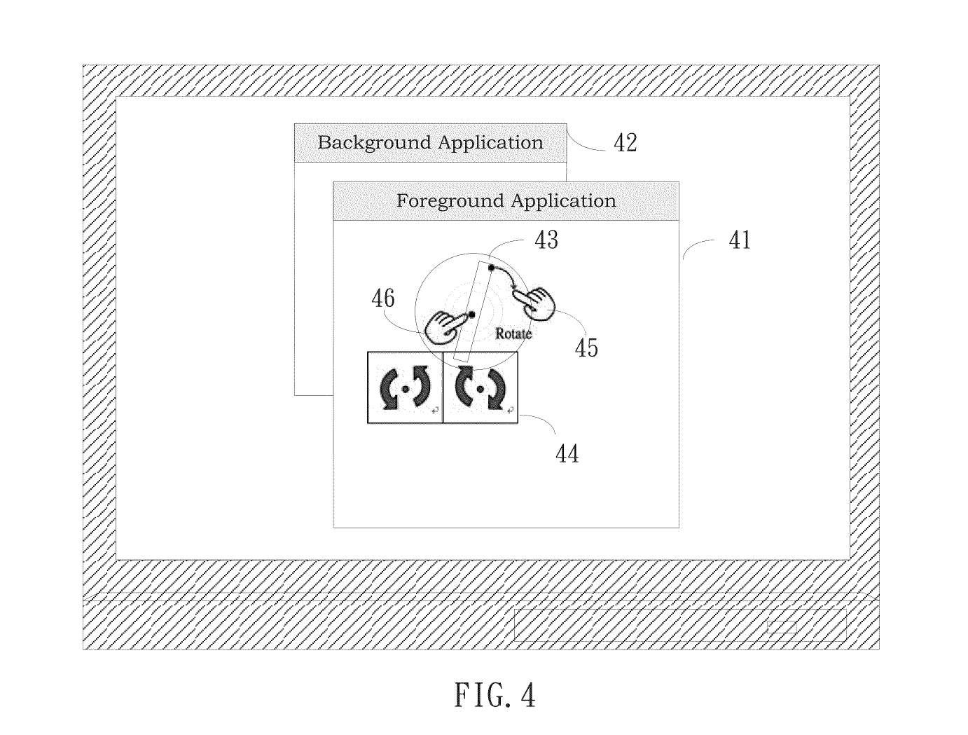

As described before, the processor 26 may further include displaying picture representing various triggers in the triggering lookup table on a display. For example, FIG. 4 shows a computer with a display. A transparent touch sensor is provided on and covering the front of the display. When the left hand 46 of a user touches or approaches a picture 43 of a rotation button on a foreground application 41, a corresponding triggering lookup table will be generated, and the pictures 44 representing various triggers in the triggering lookup table will be displayed on the display, prompting the user to rotate clockwise or anticlockwise. When the right hand 45 of the user moves in a clockwise direction, the processor 26 determines the motions of the left hand 46 and the right hand 45, and further determines the gesture is a “clockwise rotation” gesture. When this “clockwise rotation” gesture matches a trigger in the triggering lookup table, the corresponding command is triggered, for example, rotates the rotation button picture 43 by the same angle as that of the motion of the left hand 45.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A method for gesture determination, comprising:
providing a lookup table, the lookup table recording at least one gesture pattern and a trigger to which each gesture corresponds;
obtaining detection information by a sensor;
determining one or more positions of one or more objects approaching or touching the sensor based on the received detection information;
determining one or more motions of the one or more objects based on the one or more positions of the one or more objects approaching or touching the sensor;
comparing the one or more motions of the one or more objects with the at least one gesture pattern to determine a matched gesture;
comparing the matched gesture with triggers corresponding to at least one application to determine a matched trigger; and
triggering the command to which the matched trigger correspond once the matched trigger is determined.

2. The method for gesture determination according to claim 1, further comprising when there is no match between the matched gesture and the triggers corresponding to the at least one application, comparing the matched gesture with triggers corresponding to the system to determine a matched trigger.

3. The method for gesture determination according to claim 1, further comprising determining a currently executed foreground application, and the at least one application including the foreground application.

4. The method for gesture determination according to claim 1, further comprising selecting a plurality of applications based on the one or more motions of the one or more objects.

5. The method for gesture determination according to claim 4, wherein the applications are sorted applications, and these sorted applications match the trigger to which the matched gesture corresponds in order, and the first matched trigger is considered as the matched trigger.

6. The method for gesture determination according to claim 4, further comprising sorting these applications and generating a triggering lookup table based on the sorted applications, wherein a gesture corresponding to a plurality of applications corresponds only to a trigger for an application with the highest ranking among these applications in the triggering lookup table and the determination of a matched trigger is performed by comparing the matched gesture with triggers in the triggering lookup table.

7. The method for gesture determination according to claim 6, further comprising displaying pictures representing the corresponding gestures in the triggering lookup table, wherein the triggering lookup table is generated depending on the one or more motions of the one or more objects before the matched gesture is determined.

8. The method for gesture determination according to claim 4, wherein when the selected applications include a foreground application and a background application, the foreground application has a higher ranking than the background application.

9. The method for gesture determination according to claim 4, wherein the selected applications are determined based on a starting position, an ending position, or a converged range of the one or more motions of the one or more objects.

10. The method for gesture determination according to claim 1, wherein the lookup table and successive positions on the sensor approached or touched by the one or more objects are stored in a storage unit.

11. A device for gesture determination, comprising:
a lookup table for recording at least one gesture pattern and a trigger to which each gesture corresponds;
a sensor for obtaining detection information;
a controller for determining one or more positions of one or more objects approaching or touching the sensor based on the received detection information;
a processing including:
determining one or more motions of the one or more objects based on the one or more positions of the one or more objects approaching or touching the sensor;
comparing the one or more motions of the one or more objects with the at least one gesture pattern to determine a matched gesture;
comparing the matched gesture with triggers corresponding to at least one application to determine a matched trigger; and
triggering the command to which the matched trigger correspond once the matched trigger is determined.

12. The device for gesture determination according to claim 11, wherein the processor further includes when there is no match between the matched gesture and the triggers corresponding to the at least one application, comparing the matched gesture with triggers corresponding to the system to determine a matched trigger.

13. The device for gesture determination according to claim 11, wherein the processor further includes determining a currently executed foreground application, and the at least one application including the foreground application.

14. The device for gesture determination according to claim 11, wherein the processor further includes selecting a plurality of applications based on the one or more motions of the one or more objects.

15. The device for gesture determination according to claim 14, wherein the applications are sorted applications, and the processor match these sorted applications with the trigger to which the matched gesture corresponds in order, and the first matched trigger is considered as the matched trigger.

16. The device for gesture determination according to claim 14, wherein the processor further includes sorting these applications and generating a triggering lookup table based on the sorted applications, wherein a gesture corresponding to a plurality of applications corresponds only to a trigger for an application with the highest ranking among these applications in the triggering lookup table and the determination of a matched trigger is performed by comparing the matched gesture with triggers in the triggering lookup table.

17. The device for gesture determination according to claim 16, wherein the processor further includes displaying pictures representing the corresponding gestures in the triggering lookup table, wherein the triggering lookup table is generated depending on the one or more motions of the one or more objects before the matched gesture is determined.

18. The device for gesture determination according to claim 14, wherein when the selected applications include a foreground application and a background application, the foreground application has a higher ranking than the background application.

19. The device for gesture determination according to claim 14, wherein the selected applications are determined based on a starting position, an ending position, or a converged range of the one or more motions of the one or more objects.

20. The device for gesture determination according to claim 11, further comprising a storage unit for storing the lookup table and successive positions on the sensor approached or touched by the one or more objects.
